(19) United States
(12) Patent Application Publication
(10) Pub. No.: US 2013/0313093 A1
(43) Pub. Date: Nov. 28, 2013

(54) KEYBOARD DEVICE

(71) Applicant: Jung-Yu Peng, New Taipei City (TW)

(72) Inventor: Jung-Yu Peng, New Taipei City (TW)

(73) Assignee: ELITES ELECTRONICS CORP., New Taipei City (TW)

(21) Appl. No.: 13/615,639

(22) Filed: Sep. 14, 2012

(30) Foreign Application Priority Data
May 28, 2012 (TW) 101118974

(51) Int. Cl. H01H 13/70; H01H 9/18

(52) U.S. Cl. 200/5 A

(57) ABSTRACT

A keyboard device including a bottom plate, a keyboard film and button structures is provided. The keyboard film is disposed on the bottom plate and has a first electrode film, an insulating layer, and a second electrode film. The first electrode film has keypad circuits. The second electrode film is disposed opposite to the first electrode film and has light sources. The insulating layer is disposed between the first electrode film and the second electrode film. The button structures are disposed on the keyboard film.

### CROSS-REFERENCE TO RELATED APPLICATION

This application claims the priority benefit of Taiwan application serial no. 101118974, filed on May 28, 2012. The entirety of the above-mentioned patent application is hereby incorporated by reference herein and made a part of specification.

### BACKGROUND OF THE INVENTION

1. Field of the Invention

The invention relates to a keyboard device and more particularly, to a keyboard device capable of emitting light.

2. Description of Related Art

FIG. 1 is a schematic diagram of a conventional keyboard device. Referring to FIG. 1, a keyboard film 120, a push button film 130, a bridge 140 and a key 150 are successively disposed on a bottom plate 110 of a conventional keyboard device 100 from bottom to top, a light guiding plate 160 is disposed from below to the bottom plate 110 and a light source 170 is disposed on a sidewall of the light guiding plate 160.

Based on of above, it can be known that the conventional keyboard device 100 is an edge-lit keyboard, in which a light is emitted from the light source 170 to the light guiding plate 160. After a path of the light is corrected by the light guiding plate 160, the light is then emitted upwardly to the bottom of the key 150. As a result of emitting light through the transparent symbols or characters on the key 150, a user may still identify the key and perform operations in a dim environment.

However, since the conventional keyboard 100 emits light by using a reflection method, a problem of a reflecting light being distributed unevenly may still occur, resulting a poor light emitting effectiveness. Further, in order to increase the light emitting effectiveness, a reflector 180 is required to be disposed below the light guiding plate 160, which increases overall thickness of the conventional keyboard device 100.

### SUMMARY OF THE INVENTION

The invention is directed to a keyboard device capable of emitting light evenly.

The invention provides a keyboard device including a bottom plate, a keyboard film and a plurality of button structures. The keyboard film is disposed on the bottom plate and has a first electrode film, an insulating layer, and a second electrode film. The first electrode film has a plurality of keypad circuits. The second electrode film is disposed opposite to the first electrode film and has a plurality of light sources. The insulating layer is disposed between the first electrode film and the second electrode film. The plurality of button structures are disposed on the keyboard film.

In an embodiment of the invention, each of the button structures includes a bridge and a keycap. The bridge is disposed on the keyboard film. The keycap is disposed on the bridge.

In an embodiment of keyboard device of the invention, each of the light sources is located respectively below one of the keycaps.

In an embodiment of keyboard device of the invention, the first electrode film has a first surface and a second surface opposite to each other, and the keypad circuits are arranged on the first surface and/or the second surface.

In an embodiment of keyboard device of the invention, each of the light sources is a light emitting diode.

In an embodiment of keyboard device of the invention, the light-emitting diode is consisting of a single-colored emitting chip or a multi-colored emitting chip.

In an embodiment of keyboard device of the invention, the second electrode film further includes a light source driving circuit, and the light sources are respectively controlled by the light source driving circuit.

In an embodiment of keyboard device of the invention, the second electrode film has a first surface and a second surface opposite to each other, and the light source driving circuit is disposed on the first surface and/or the second surface.

In an embodiment of keyboard device of the invention, the first electrode film is made of a transparent material.

In an embodiment of keyboard device of the invention, the second electrode film is made of a transparent material.

In an embodiment of keyboard device of the invention, the first electrode film is disposed on the bottom plate.

In an embodiment of keyboard device of the invention, the second electrode film is disposed on the bottom plate.

Based on above, in the keyboard device of the invention, one of the light sources is respectively disposed below each of the button structures, thereby increasing light emitting evenness of the keyboard device. Further, elements such as light guiding plates and reflectors are omitted in the invention, such that the keyboard device of the invention may be more compact by having a thickness thinner than that in conventional art. In addition, since arrangement of the keypad circuits and disposition of the light sources are respectively arranged on the first electrode film and the second electrode film, the area for arranging the keypad circuits may be increased to further reduce the complexity of wiring the keypad circuits.

To make the above features and advantages of the invention more comprehensible, several embodiments accompanied with drawings are described in detail as follows.

### BRIEF DESCRIPTION OF THE DRAWINGS

FIG. 1 is a schematic diagram of a conventional keyboard device.

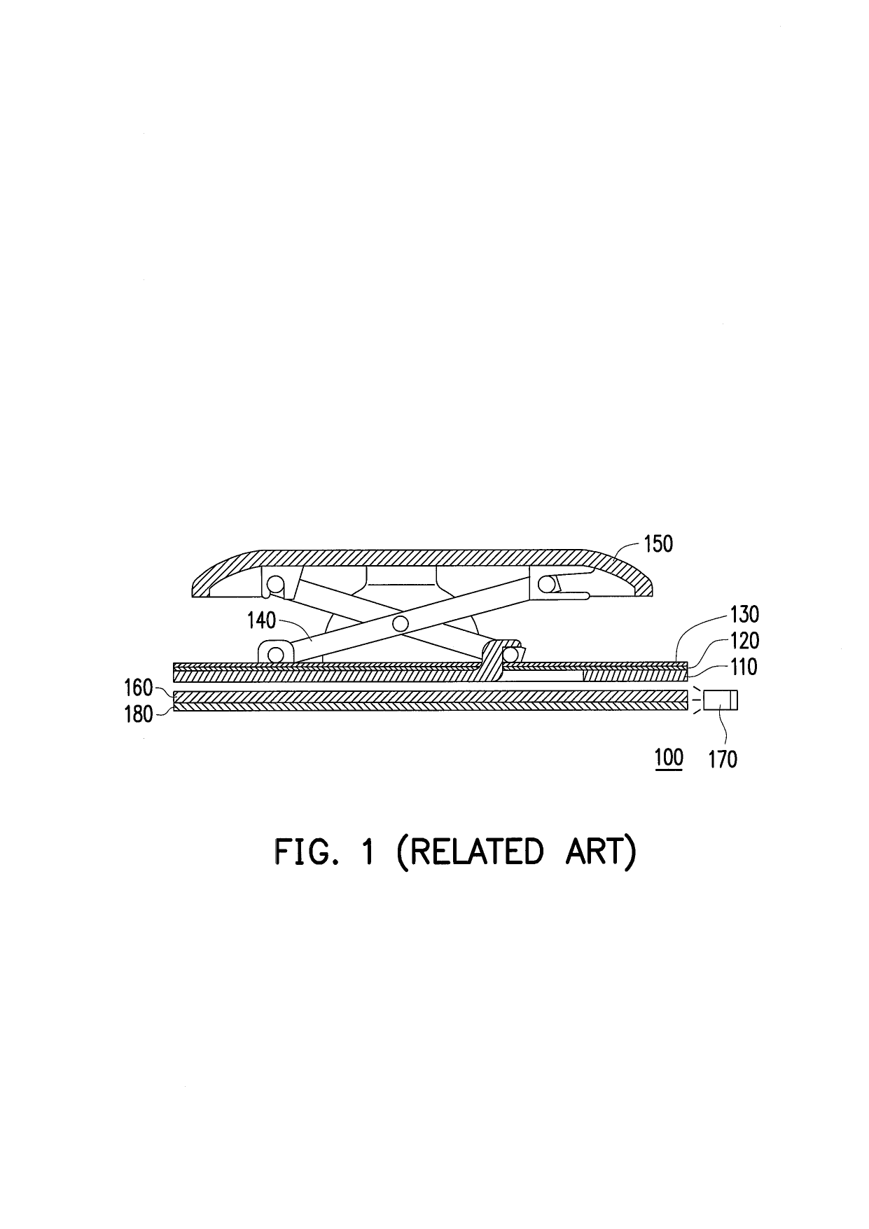

FIG. 2 is a schematic breakdown view illustrating a keyboard device according to an embodiment of the invention.

FIG. 3 is a schematic breakdown view of a keyboard film of the keyboard device illustrated in FIG. 2.

FIG. 4 is a magnified view of area A of FIG. 2.

FIG. 5 is a schematic breakdown view illustrating a keyboard device according to another embodiment of the invention.

FIG. 6 is a schematic breakdown view of a keyboard film of the keyboard device illustrated in FIG. 5.

### DESCRIPTION OF THE EMBODIMENTS

### First Embodiment

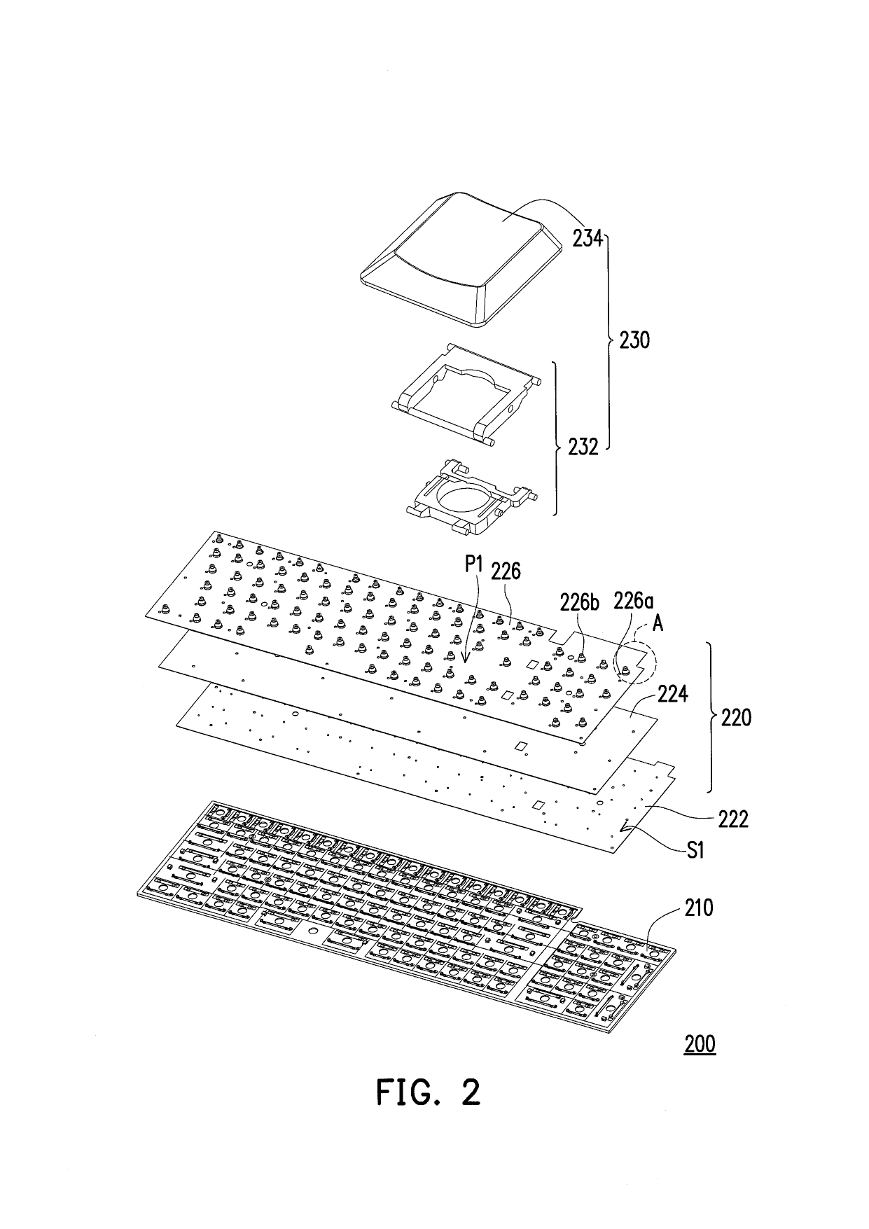

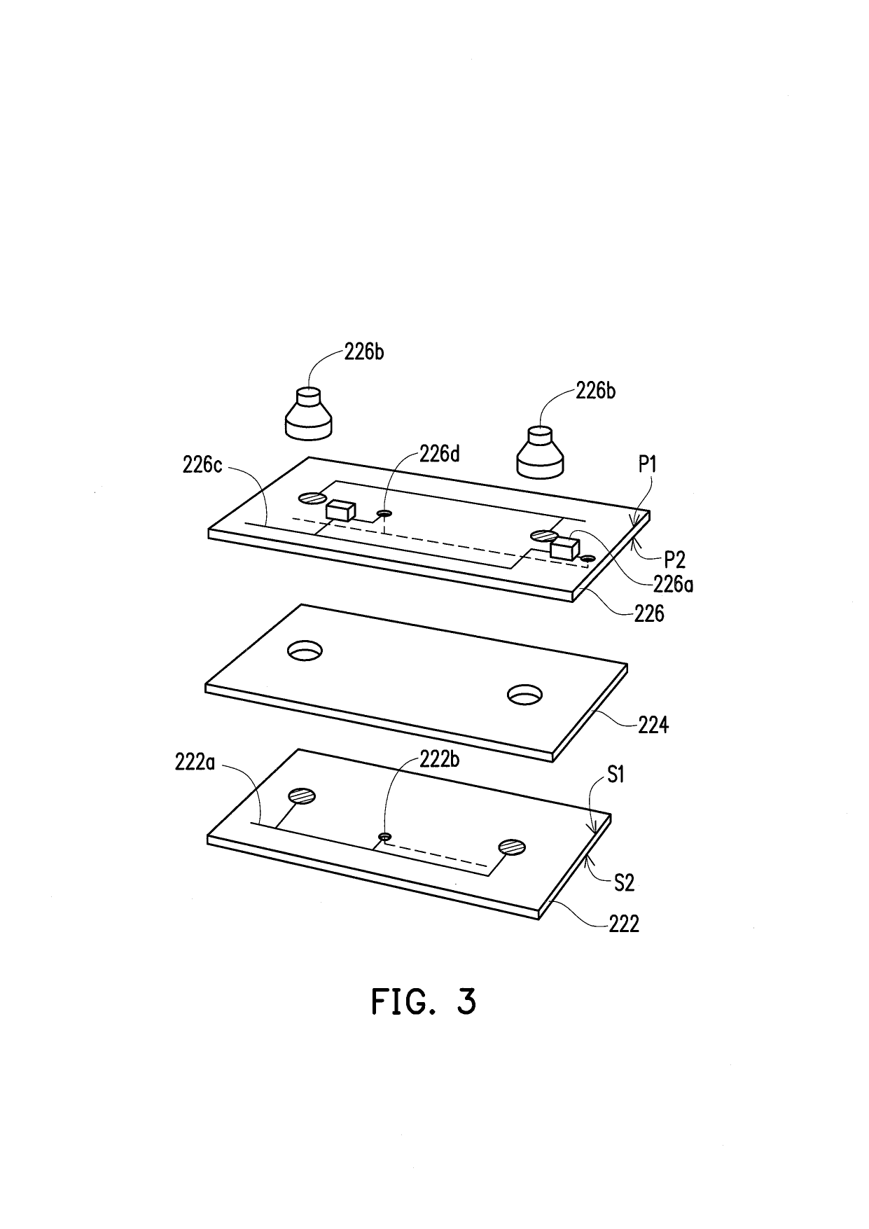

FIG. 2 is a schematic breakdown view illustrating a keyboard device according to an embodiment of the invention. FIG. 3 is a schematic breakdown view of a keyboard film of the keyboard device illustrated in FIG. 2. Elements illustrated in the figures are not completely drawn to scale for the purpose of better comprehension. Referring to FIG. 2 and FIG. 3 together, a keyboard device 200 of the present embodiment includes a bottom plate 210, a keyboard film 220 and a plurality of button structures 230. The keyboard film 220 is disposed on the bottom plate 210 and has a first electrode film 222, an insulating layer 224 and a second electrode film 226. In the present embodiment, the first electrode film 222 is disposed on the bottom plate 210, the insulating layer 224 is located on the first electrode film 222, and the second electrode film 226 is located on the insulating layer 224.

In the keyboard device 200 of the present embodiment, the first electrode film 222 has a plurality of keypad circuits 222a, and the second electrode film has a plurality of light sources 226a. In other words, the light sources 226a and the keypad circuits 222a are respectively disposed on different electrode films. Since only the keypad circuit 222a is disposed the first electrode film 222, the area for arranging the keypad circuits may be substantially increased, thereby reducing the complexity of wiring the keypad circuits 222a.

More specifically, as shown in FIG. 3, the first electrode film 222 has a first surface S1 and a second surface S2 opposite to each other. The keypad circuits 222a may be arranged on the first surface S1 or the second surface S2 of the first electrode film 222, or simultaneously arranged on both the first surface S1 and the second surface S2 based on practical requirements. In the present embodiment, the keypad circuits 222a are arranged on the first surface S1 and the second surface S2 of the first electrode film 222. In this case, the first electrode film 222 has at least one through vias 222b, the keypad circuits 222a are arranged on the first surface S1 and the second surface S2 via the through vias 222b.

As described above, by disposing the keypad circuits 222a on the first surface S1 or the second surface S2 of the first electrode film 222, the area for wiring the keypad circuits 222a may be increased to simplify the wiring process.

In addition, the second electrode film 226 has a first surface P1 and a second surface P2 opposite to each other. According to a light emitting direction of the light source 226a, the light source 226a may be disposed on the first surface P1 or the second surface P2 of the second electrode film 226, or the light source 226a may be simultaneously disposed on both the first surface P1 and the second surface P2. In the present embodiment, the light sources 226a are disposed on the first surface P1 of the second electrode film 226. The light sources 226a may be a light-emitting diode or other light-emitting elements. Specifically, the light sources 226a may be consisting of a single-colored emitting chip, or a multi-colored emitting chip in order that the light sources 226a emit another colored light or emit a multiple-colored (two or more) light.

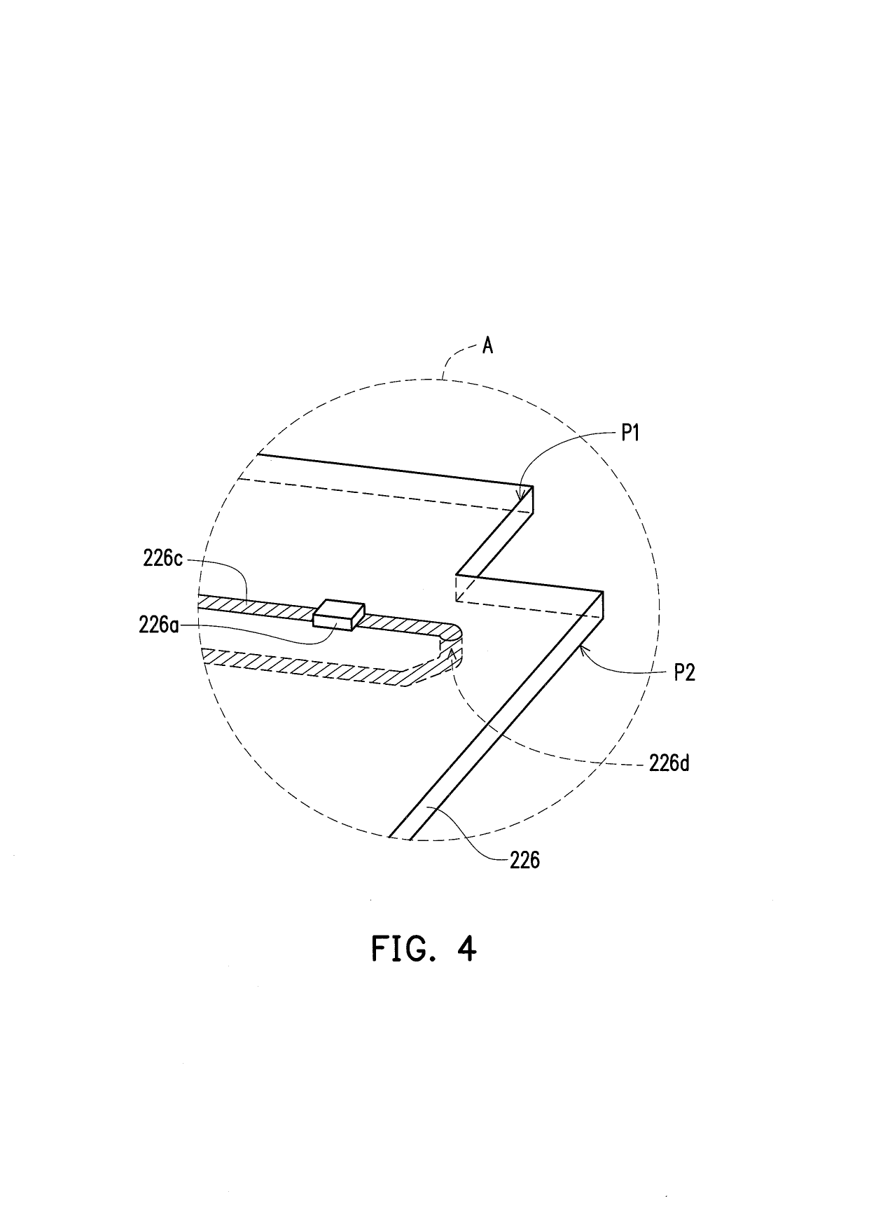

FIG. 4 is a magnified view of area A of FIG. 2. Referring to FIG. 4, the second electrode film 226 further includes a light source driving circuit 226c, and the light sources 226a are respectively controlled by the light source driving circuit 226c. The light source driving circuit 226c may be arranged on the first surface P1 or the second surface P2, or the light source driving circuit 226c may be simultaneously arranged on both the first surface P1 and the second surface P2, the invention is not limited thereto. Moreover, the second electrode 226 of the keyboard film 220 may further include at least one via hole 226d, the light source driving circuit 226c is arranged on the first surface P1 and/or the second surface P2 of the second electrode film 226 via the via hole 226d and electrically connected to the light sources 226a.

As described above, the wiring process of the keypad 222a may be simplified by disposing the keypad circuits 222a and the light sources 226a on different electrode films. As a result, the entire manufacturing process of the keyboard device 200 in the present embodiment may be substantially simplified, thereby reducing the time and costs for the manufacturing process.

Referring to FIG. 2, besides having the plurality of light sources 226a, the second electrode film 226 may further includes a plurality of pressing bumps 226b, and each of the pressing bumps 226b. Moreover, each of the button structures 230 includes a bridge 232 and a keycap 234. The bridge 232 is disposed on the second electrode film 226, the keycap 234 is disposed on the bridge 232 and each of the light sources 226a is located respectively below one of the keycaps 234.

Referring to FIG. 2, when assembling the keyboard device 200, firstly, the keyboard film 220 is disposed on the bottom plate 210. Next, the bridge 232 of each button structure 230 is assembled to the second electrode film 226. Lastly, the keycap 234 is assembled on the bridge 232.

In the present embodiment, the first electrode 222 and the second electrode 266 may both be made of a transparent material. Further, since the light sources 226a are disposed respectively below each keycap 234, light emitted from the light source 226a may be directly emitted towards the keycap 234 without a correction of reflection or path, thereby increasing light source utilization thereof while allowing the keyboard device 200 to have an even light emitting effectiveness.

In addition, since the light sources 226a are disposed respectively below each keycap 234, the keyboard device 200 is capable of emitting light entirely or partially. Moreover, the keyboard 200 may also simultaneously emit light with different colors through each of the light source 226a having different colors.

### Second Embodiment

The present embodiment is approximately identical to the first embodiment, descriptions related thereto is omitted hereinafter and same or similar reference numerals used in the present embodiment represent the same or similar elements. The difference between the embodiments is described as follows.

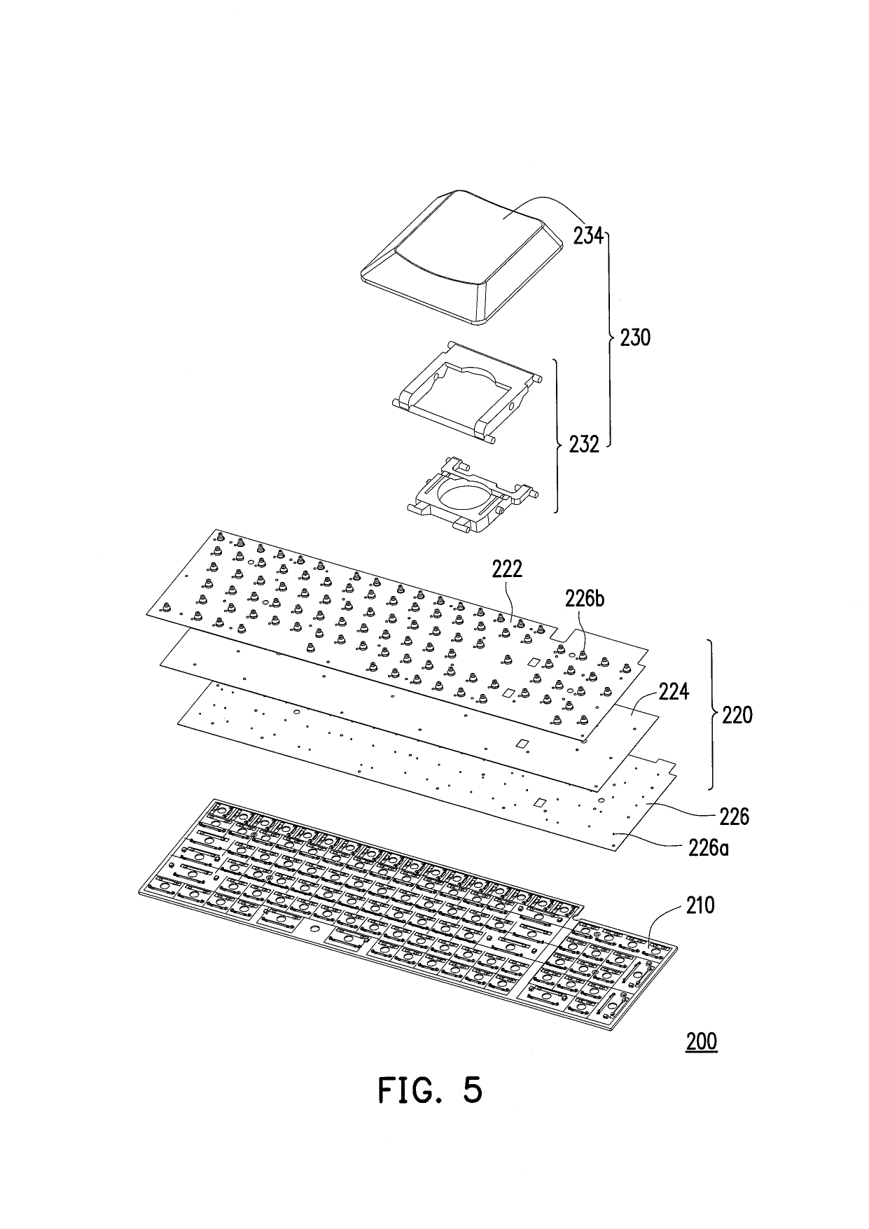

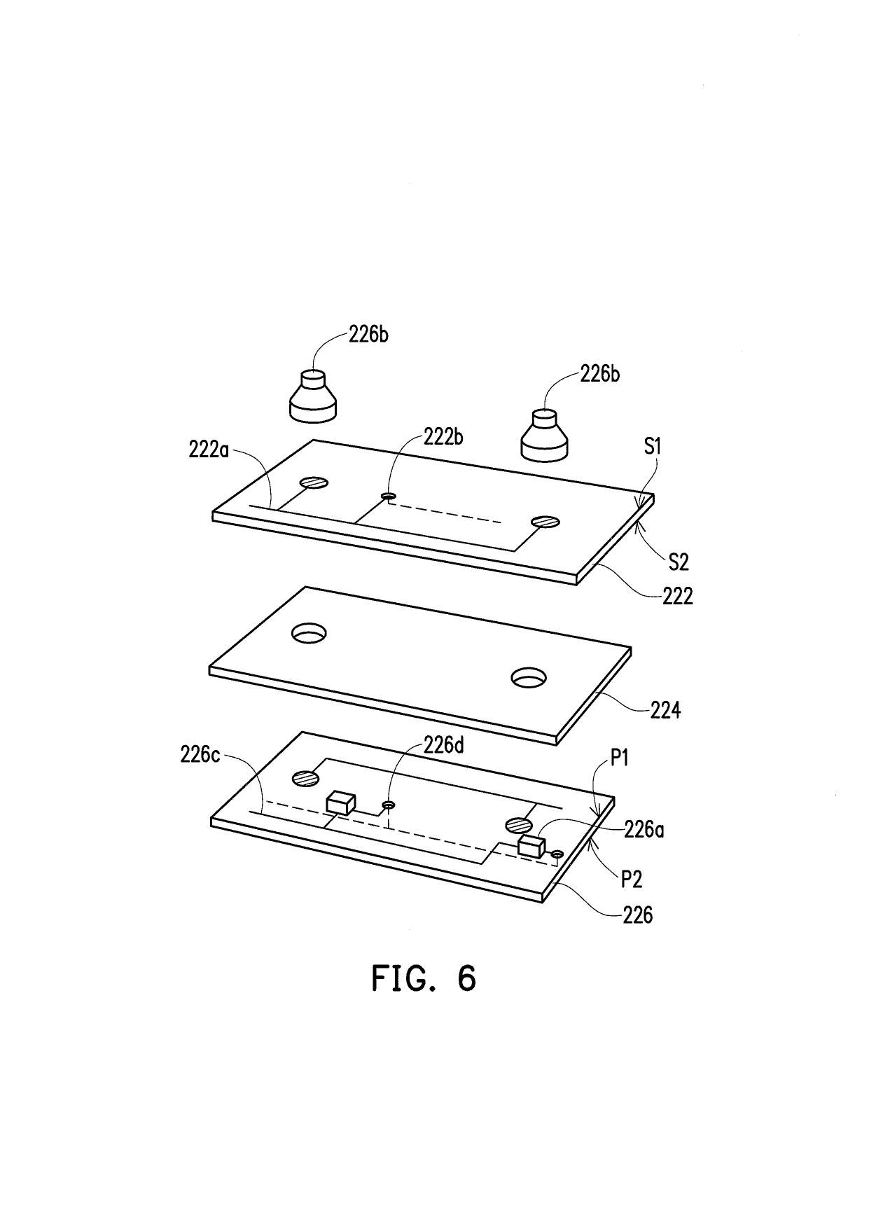

FIG. 5 is a schematic breakdown view illustrating a keyboard device according to another embodiment of the invention. FIG. 6 is a schematic breakdown view of a keyboard film of the keyboard device illustrated in FIG. 5. Referring to FIG. 5, the difference between the present embodiment and the first embodiment lies where disposing order of the first electrode film 222, the insulating layer 224 and the second electrode film 226 of the keyboard film 220 on the bottom plate 210 are different. In the first embodiment, the first electrode film 222 is disposed on the bottom plate 210, whereas the second electrode film 226 is disposed on the bottom plate 210 in the second embodiment.

Referring to FIG. 5 and FIG. 6, in the present embodiment, besides that the first electrode film 222 has the plurality of keypad circuits 222a and the plurality of through vias 222b, a plurality of pressing bumps 226b are further disposed on the first electrode film 222. In addition, when assembling the keyboard device 200, the keyboard film 220 is firstly being disposed on the bottom plate 210. Next, each bridge 232 of the button structures 230 is assembled to the keyboard film 220. Lastly, the keycap 234 is assembled on the bridge 232.

In view of above, components disposition of the keyboard device of the invention is differently from that in conventional art, which directly disposing the light source below the keycap in order to increase light source utilization. In addition, the keyboard device may emit light evenly in comparing to the conventional art by respectively disposing one light source below each keycap of the button structures. Moreover, the light sources may be a light-emitting diodes having different colors, so that light having different colors may be emitted when the keyboard device is in an inactivated state and when the button structures are pressed to activate. Further, elements such as light guiding plates and reflectors are omitted in the invention, such that the keyboard device of the invention may be more compact by having a thickness thinner than that in conventional art. In addition, since arrangement of the keypad circuits and disposition of the light sources are respectively arranged on the first electrode film and the second electrode film, the area for the arranging of the keypad circuits may be increased to further reduce the complexity of wiring the keypad circuits.

Although the invention has been described with reference to the above embodiments, it is apparent to one of the ordinary skill in the art that modifications to the described embodiments may be made without departing from the spirit of the invention. Accordingly, the scope of the invention will be defined by the attached claims not by the above detailed descriptions.

What is claimed:

1. A keyboard device, comprising:
a bottom plate;
a keyboard film disposed on the bottom plate, wherein the keyboard film comprises:
a first electrode film having a plurality of keypad circuits;
a second electrode film having a plurality of light sources and disposed correspondingly to the first electrode film; and
an insulating layer disposed between the first electrode film and the second electrode film; and
a plurality of button structures disposed on the keyboard film.

2. The keyboard device of claim 1, wherein each of the button structures comprises:
a bridge disposed on the keyboard film; and
a keycap disposed on the bridge.

3. The keyboard device of claim 2, wherein each of the light sources is located respectively below one of the keycaps.

4. The keyboard device of claim 1, wherein the first electrode film has a first surface and a second surface opposite to each other, and the keypad circuits are arranged on the first surface and/or the second surface.

5. The keyboard device of claim 1, wherein each of the light sources is a light-emitting diode.

6. The keyboard device of claim 5, wherein the light-emitting diode is consisting of a single-colored emitting chip or a multi-colored emitting chip.

7. The keyboard device of claim 1, wherein the second electrode film further comprises a light source driving circuit, and the light sources are respectively controlled by the light source driving circuit.

8. The keyboard device of claim 7, wherein the second electrode film has a first surface and a second surface opposite to each other, and the light source driving circuit is disposed on the first surface and/or the second surface.

9. The keyboard device of claim 1, wherein the first electrode film is made of a transparent material.

10. The keyboard device of claim 1, wherein the second electrode film is made of a transparent material.

11. The keyboard device of claim 1, wherein the first electrode is disposed on the bottom plate.

12. The keyboard device of claim 1, wherein the second electrode is disposed on the bottom plate.
